(19) United States
(12) Patent Application Publication
(10) Pub. No.: US 2026/0145698 A1
(43) Pub. Date: May 28, 2026

(54) CONTROL DEVICE, CONTROL METHOD, AND STORAGE MEDIUM

(71) Applicant: HONDA MOTOR CO., LTD., Tokyo (JP)

(72) Inventors: Kazuki YAMANO, Tokyo (JP); Yuki HARA, Tokyo (JP)

(73) Assignee: HONDA MOTOR CO., LTD., Tokyo (JP)

(21) Appl. No.: 19/397,399

(22) Filed: Nov. 21, 2025

(30) Foreign Application Priority Data
Nov. 22, 2024 (JP) 2024-203593

(51) Int. Cl. B60W 50/14; G08G 1/14

(52) U.S. Cl. CPC B60W 50/14; G08G 1/143; B60W 2050/143; B60W 2050/146; B60W 2520/105; B60W 2540/106

(57) ABSTRACT

A control device performs movement control to move a vehicle from a movement start point to a parking section based on parking information indicating the movement start point, the parking section, and a route from the movement start point to the parking section. The control device includes processing circuitry configured to issue a notification that proposes execution of the movement control to a user in response to the vehicle being positioned near the movement start point indicated by the parking information, receive a response operation to the notification from the user, and inhibit the notification in response to non-execution of the movement control in relation to the notification.

This application is based upon and claims the benefit of priority from prior Japanese patent application No. 2024-203593, filed on Nov. 22, 2024, the entire contents of which are incorporated herein by reference.

### TECHNICAL FIELD

The present disclosure relates to a control device, a control method, and a storage medium storing a control program.

### BACKGROUND ART

In recent years, efforts have been actively made to provide access to a sustainable transportation system in consideration of vulnerable people among traffic participants. In order to implement the above, research and development on further improving safety and convenience of traffic by research and development related to driving assistance technology have been focused on.

In an autonomous driving system that causes a vehicle to travel autonomously without requiring a driving operation of a user, it has been known that a route taken when a vehicle travels to a target position by a driving operation of a user is stored, and when the vehicle travels toward the same target position or on the same route, the vehicle is caused to travel based on a stored route history. In addition, it is known that route information on a route from a current position to the target position is generated based on information acquired by an in-vehicle sensor to cause the vehicle to travel.

For example, JP2024-024924A describes a parking assistance device that is configured to execute parking assistance control with a registered parking position as a target parking position when a current position of a vehicle acquired by a position acquisition device is a point near the registered parking position stored in a memory, and that is configured to determine whether a position near a registered candidate point is a position where it is impossible to park the vehicle by the parking assistance control, and to perform proposal processing if it is determined that the position is not impossible to park, and not to perform the proposal processing if it is determined that the position is impossible to park.

CN111376894A describes an autonomous parking system that autonomously parks a vehicle at a certain parking space, the autonomous parking system including: a positioning device used to acquire a current position of the vehicle; a storage device that stores a start position for autonomous parking of the vehicle and a predetermined parking route set in advance; a receiving device that receives a parking request from a user; and a control device that, when the receiving device receives a parking request, acquires the start position and the predetermined parking route from the storage device, determines whether the current position acquired by the positioning device is within an error range of the start position, and, if the current position is within the error range of the start position, causes the vehicle to travel according to the predetermined parking route and park in a parking space.

JP2022-133230A describes a parking assistance method for executing autonomous traveling of a vehicle based on a parking operation performed in the past, the parking assistance method including: a storage step of storing, in a storage unit, information on at least one of a traveling route and a parking target position in the parking operation performed in the past, and a display step of causing a display unit to display guidance information on a target position where the autonomous traveling of the vehicle based on at least one of the traveling route and the parking target position is possible.

JP2023-176548A describes a parking assistance device that is configured to, when a registered feature and/or three-dimensional object is detected near a registered route based on a top view image and three-dimensional object information, calculate the registered route based on position coordinates of the feature and/or position coordinates of the three-dimensional object, and when it is determined that parking assistance control of the vehicle can be started based on a relative position and a relative orientation of the vehicle with respect to the registered route, notify a driver by display or audio of a first section in which the parking assistance control can be started if a start condition is satisfied.

### SUMMARY OF INVENTION

As shown in JP2024-024924A, CN111376894A, JP2022-133230A, and JP2023-176548A, vehicle parking control is described in which, when a vehicle is autonomously parked at a predetermined parking position, if it is determined that autonomous parking is possible, a driver is notified of guidance information on the autonomous parking. However, there is no description of measures to prevent the notification of the guidance information on the autonomous parking from being repeatedly performed or performed more than necessary depending on a traveling route of the vehicle.

Aspects of the present disclosure relate to providing a control device, a control method, and a storage medium storing a control program that can improve usability near a parking section.

According to an aspect of the present disclosure, there is provided a control device that performs movement control to move a vehicle from a movement start point to a parking section based on parking information indicating the movement start point, the parking section, and a route from the movement start point to the parking section, the control device including:

processing circuitry configured to

issue a notification that proposes execution of the movement control to a user in response to the vehicle being positioned near the movement start point indicated by the parking information,

receive a response operation to the notification from the user, and

inhibit the notification in response to non-execution of the movement control in relation to the notification.

According to another aspect of the present disclosure, there is provided a control method of a control device that performs movement control to move a vehicle from a movement start point to a parking section based on parking information indicating the movement start point, the parking section, and a route from the movement start point to the parking section, the control method including:

issuing, by the control device, a notification that proposes execution of the movement control to a user in response to the vehicle being positioned near the movement start point indicated by the parking information,

receiving, by the control device, a response operation to the notification from the user, and

inhibiting, by the control device, the notification in response to non-execution of the movement control in relation to the notification.

According to another aspect of the present disclosure, there is provided a non-transitory computer-readable storage medium storing a control program causing a processor of a control device to execute a process, the control device performing movement control to move a vehicle from a movement start point to a parking section based on parking information indicating the movement start point, the parking section, and a route from the movement start point to the parking section, the process including:

issuing a notification that proposes execution of the movement control to a user in response to the vehicle being positioned near the movement start point indicated by the parking information,

receiving a response operation to the notification from the user, and

inhibiting the notification in response to non-execution of the movement control in relation to the notification.

According to the aspects of the present disclosure, it is possible to provide a control device, a control method, and a storage medium storing a control program that can improve usability near a parking section. This hence may contribute to development of a sustainable transportation system.

### BRIEF DESCRIPTION OF DRAWINGS

Exemplary embodiment(s) of the present invention will be described in detail based on the following figures, wherein:

FIG. 1 is a side view of an example of a vehicle 10 equipped with a control device of the present disclosure;

FIG. 2 is a top view of the vehicle 10 illustrated in FIG. 1;

FIG. 3 is a block diagram illustrating an example of an internal configuration of the vehicle 10 illustrated in FIG. 1;

FIG. 4 is a diagram illustrating an example of parking information for the vehicle 10 in a parking facility;

FIG. 5 is a diagram illustrating an example of a plurality of pieces of parking information in a parking facility 60;

FIG. 6 is a flowchart illustrating a first example of control processing relating to memory parking;

FIG. 7 is a flowchart illustrating a second example of the control processing relating to the memory parking;

FIG. 8 is a diagram illustrating an example of a suggestion screen that proposes execution of movement control (memory parking) to a user;

FIG. 9 is a flowchart illustrating cancellation processing for canceling a suggestion disabled mode;

FIG. 10 is a flowchart illustrating cancellation processing for canceling disabling of a suggestion; and

FIG. 11 is a diagram illustrating an example of a parking facility including a plurality of parking areas.

### DESCRIPTION OF EMBODIMENTS

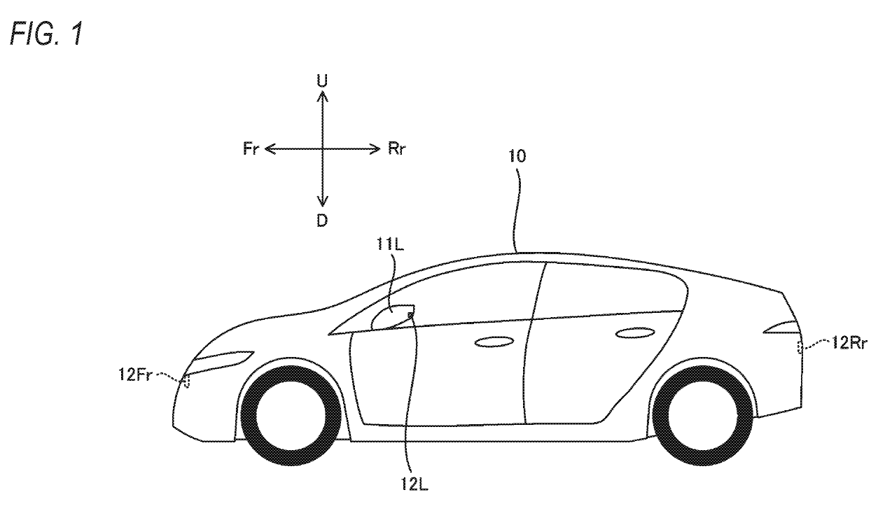

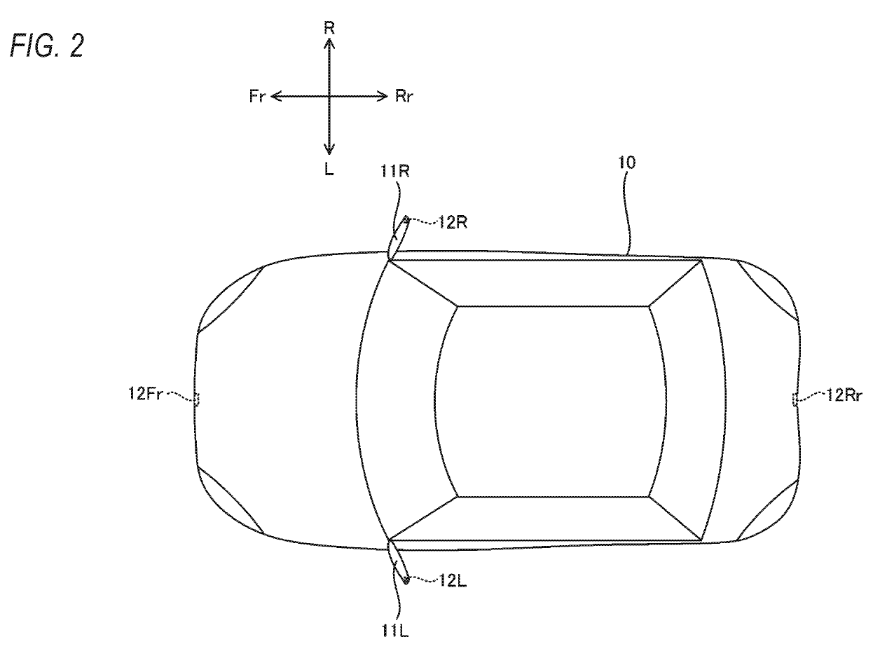

Hereinafter, an embodiment of a control device, a control method, and a storage medium storing a control program of the present disclosure will be described with reference to the accompanying drawings. The drawings are viewed in directions of reference numerals. In order to simplify and clarify the description in the present specification or the like, a front-rear direction, a left-right direction, and an upper-lower direction are described according to directions viewed from a driver of a vehicle 10 illustrated in FIGS. 1 and 2. In the drawings, a front side of the vehicle 10 is shown as Fr, a rear side is shown as Rr, a left side is shown as L, a right side is shown as R, an upper side is shown as U, and a lower side is shown as D.

### Vehicle 10 Equipped with Control Device

FIG. 1 is a side view of an example of the vehicle 10 equipped with a control device of the present invention. FIG. 2 is a top view of the vehicle 10 illustrated in FIG. 1.

The vehicle 10 is an automobile including a drive source (not illustrated) and wheels including drive wheels driven by power of the drive source and steerable steered wheels. In the present embodiment, the vehicle 10 is a four-wheeled automobile including a pair of left and right front wheels and a pair of left and right rear wheels. The drive source of the vehicle 10 is, for example, an electric motor. The drive source of the vehicle 10 may be an internal combustion engine such as a gasoline engine or a diesel engine, or a combination of an electric motor and an internal combustion engine. The drive source of the vehicle 10 may drive the pair of left and right front wheels, the pair of left and right rear wheels, or four wheels including the pair of left and right front wheels and the pair of left and right rear wheels. The front wheels and the rear wheels may all be steerable steered wheels, or the front wheels or the rear wheels may be steerable steered wheels.

The vehicle 10 further includes side mirrors 11L and 11R. The side mirrors 11L and 11R are mirrors (back mirrors) provided on outer sides of front seat doors of the vehicle 10 for the driver to check the rear side and rear lateral sides. The side mirrors 11L and 11R are fixed to a body of the vehicle 10 by rotation shafts extending in a vertical direction, and may be opened and closed by pivoting about the rotation shafts.

The vehicle 10 further includes a front camera 12Fr, a rear camera 12Rr, a left side camera 12L, and a right side camera 12R. The front camera 12Fr is an imaging device (for example, a digital camera) that is provided on the front side of the vehicle 10 and captures an image in a forward direction of the vehicle 10. The rear camera 12Rr is a digital camera that is provided on the rear side of the vehicle 10 and captures an image in a rearward direction of the vehicle 10. The left side camera 12L is a digital camera that is provided on the left side mirror 11L of the vehicle 10 and captures an image in a leftward direction of the vehicle 10. The right side camera 12R is a digital camera that is provided on the right side mirror 11R of the vehicle 10 and captures an image in a rightward direction of the vehicle 10.

### Internal Configuration of Vehicle 10

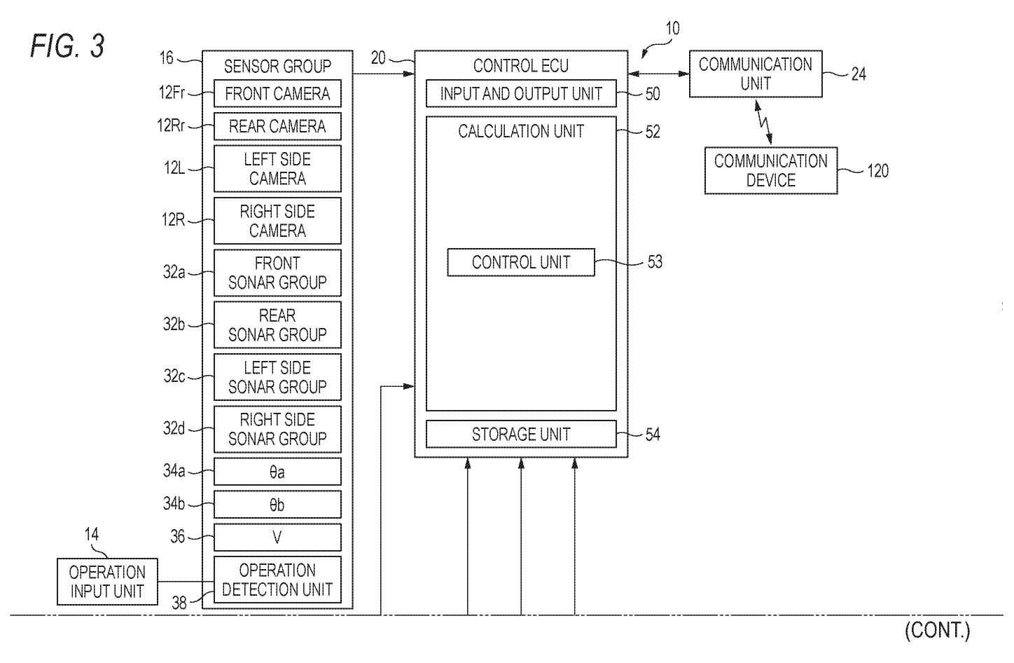

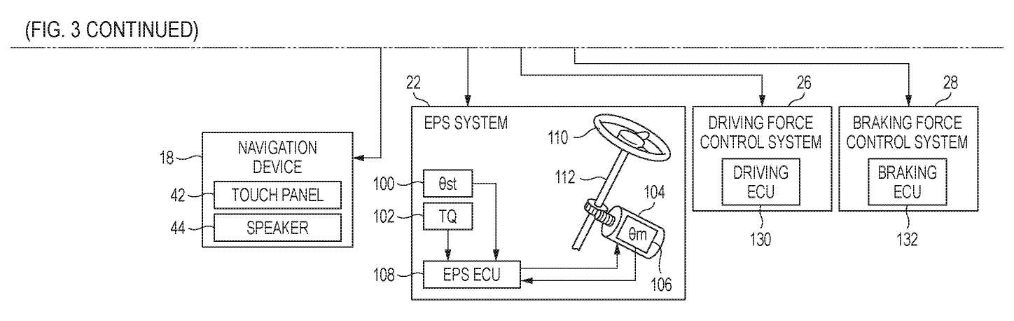

FIG. 3 is a block diagram illustrating an example of an internal configuration of the vehicle 10 illustrated in FIG. 1. As illustrated in FIG. 3, the vehicle 10 includes a sensor group 16, a navigation device 18, a control electronic control unit (ECU) 20, an electric power steering (EPS) system 22, and a communication unit 24. The vehicle 10 further includes a driving force control system 26 and a braking force control system 28.

The sensor group 16 acquires various detection values used for control by the control ECU 20. The sensor group 16 includes the front camera 12Fr, the rear camera 12Rr, the left side camera 12L, and the right side camera 12R. The sensor group 16 also includes a front sonar group 32a, a rear sonar group 32b, a left side sonar group 32c, and a right side sonar group 32d. The sensor group 16 includes wheel sensors 34a and 34b, a vehicle speed sensor 36, and an operation detection unit 38. Although not illustrated, the sensor group 16 also includes an acceleration sensor capable of measuring an acceleration of the vehicle 10.

The front camera 12Fr, the rear camera 12Rr, the left side camera 12L, and the right side camera 12R acquire periphery recognition data (for example, peripheral images) for recognizing surroundings of the vehicle 10 by capturing images of a periphery of the vehicle 10. The peripheral images of the vehicle 10 captured by the front camera 12Fr, the rear camera 12Rr, the left side camera 12L, and the right side camera 12R are referred to as a front image, a rear image, a left side image, and a right side image, respectively. An image constituted by the left side image and the right side image may be referred to as a side image. An image of the vehicle 10 and the periphery of the vehicle, which is generated by combining the images captured by the front camera 12Fr, the rear camera 12Rr, the left side camera 12L, and the right side camera 12R, is referred to as a top view image of the vehicle 10.

The front sonar group 32a, the rear sonar group 32b, the left side sonar group 32c, and the right side sonar group 32d emit sound waves to the periphery of the vehicle 10, and receive reflected sounds from other objects. The front sonar group 32a includes, for example, four sonars. The sonars that constitute the front sonar group 32a are respectively provided on an obliquely left front side, a front left side, a front right side, and an obliquely right front side of the vehicle 10. The rear sonar group 32b includes, for example, four sonars. The sonars that constitute the rear sonar group 32b are respectively provided on an obliquely left rear side, a rear left side, a rear right side, and an obliquely right rear side of the vehicle 10. The left side sonar group 32c includes, for example, two sonars. The sonars that constitute the left side sonar group 32c are provided at a left side front portion and a left side rear portion of the vehicle 10, respectively. The right side sonar group 32d includes, for example, two sonars. The sonars that constitute the right side sonar group 32d are provided at a right side front portion and a right side rear portion of the vehicle 10, respectively.

The wheel sensors 34a and 34b detect rotation angles of the wheels of the vehicle 10. The wheel sensors 34a and 34b may be implemented by angle sensors or displacement sensors. The wheel sensors 34a and 34b output detection pulses each time the wheels rotate by a predetermined angle. The detection pulses output from the wheel sensors 34a and 34b are used to calculate rotation angles and rotation speeds of the wheels. A movement distance of the vehicle 10 is calculated based on the rotation angles of the wheels. The wheel sensor 34a detects, for example, a rotation angle θa of the left rear wheel. The wheel sensor 34b detects, for example, a rotation angle θb of the right rear wheel.

The vehicle speed sensor 36 detects a speed of a vehicle body of the vehicle 10, that is, a vehicle speed V, and outputs the detected vehicle speed V to the control ECU 20. The vehicle speed sensor 36 detects the vehicle speed V based on, for example, rotation of a transmission countershaft.

The operation detection unit 38 detects an operation content of a user performed using an operation input unit 14, and outputs the detected operation content to the control ECU 20. The operation input unit 14 includes various user interfaces such as a side mirror switch that switches the side mirrors 11L and 11R between opened and closed states, and a shift lever (a selector lever or a selector).

The navigation device 18 detects a current position (position coordinates) of the vehicle 10 by using, for example, a global positioning system (GPS), and guides the user along a movement route to a destination. The navigation device 18 includes a storage device (not illustrated) including a map information database. The navigation device 18 also includes a touch panel 42 and a speaker 44. The touch panel 42 functions as an input device and a display device of the control ECU 20. The speaker 44 outputs various types of guidance information to the user of the vehicle 10 by voice.

The touch panel 42 enables input of various commands to the control ECU 20. For example, the user may input a command related to movement assistance of the vehicle 10 via the touch panel 42. The movement assistance includes parking assistance and exiting assistance of the vehicle 10. The touch panel 42 displays various screens related to control contents of the control ECU 20. For example, the touch panel 42 displays a screen related to the movement assistance of the vehicle 10. Specifically, the touch panel 42 displays a parking assistance button for requesting parking assistance of the vehicle 10 and an exiting assistance button for requesting exiting assistance. The parking assistance button includes a memory parking button for requesting parking by automatic steering of the control ECU 20, and a parking support button for requesting support while parking the vehicle by an operation of the user. The exiting assistance button includes a memory exiting button for requesting exiting by the automatic steering of the control ECU 20, and an exiting support button for requesting support while exiting by an operation of the user. Note that a constituent element other than the touch panel 42, for example, an information terminal such as a smartphone or a tablet may be used as the input device or the display device.

The "parking", for example, is a stop as the user gets on and off the vehicle, and excludes a temporary stop due to a traffic signal or the like. Further, the "parking section" means a section where the vehicle 10 is to be stopped, that is, a section to be parked.

The control ECU 20 includes an input and output unit 50, a calculation unit 52, and a storage unit 54. The calculation unit 52 is implemented by, for example, processing circuitry or a central processing unit (CPU). The calculation unit 52 executes various types of control by controlling units based on a program stored in the storage unit 54. The calculation unit 52 receives and outputs signals from and to each unit connected to the control ECU 20 via the input and output unit 50. The control ECU 20 is an example of a "control device" in the present invention.

The storage unit 54 stores information on memory movement (memory parking or exiting) of the vehicle 10. The information on the memory movement is information for autonomous movement or assisted movement of the vehicle 10 based on pre-stored movement information. For example, the storage unit 54 stores parking information indicating a movement start point from which the memory movement starts, a parking section where the vehicle 10 is stopped by the memory movement, and a route from the movement start point to the parking section.

The calculation unit 52 includes a control unit 53 that performs movement control of the vehicle 10. The control unit 53 performs memory parking assistance and memory exiting assistance of the vehicle 10 through automatic steering in which a steering 110 is automatically operated under control of the control unit 53. In the memory parking assistance and the memory exiting assistance, an accelerator pedal (not illustrated), a brake pedal (not illustrated), and the operation input unit 14 are automatically operated. The control unit 53 performs support parking assistance and support exiting assistance when the user (driver) operates the accelerator pedal, the brake pedal, and the operation input unit 14 to perform manual parking and manual exiting of the vehicle 10. Note that during the memory parking assistance and the memory exiting assistance, the driver may be in a state of being present in the vehicle 10, or may be in a state of getting off the vehicle 10 and being outside (not being present in the vehicle).

For example, the control unit 53 performs the movement control of the vehicle 10 based on the periphery recognition data of the vehicle 10 acquired by the front camera 12Fr, the rear camera 12Rr, the left side camera 12L, and the right side camera 12R, the movement start point, a designated parking section, and a route from the movement start point to the parking section. The movement control includes parking control for performing memory parking on the vehicle 10 in a predetermined parking section (target parking position) from the movement start point, and exiting control for performing memory exiting on the vehicle 10 from the parking section to a predetermined exiting section (target exit position). The control unit 53 can execute the parking control and the exiting control based on an instruction signal input via the input and output unit 50. The input instruction signal includes an instruction signal transmitted by wireless communication from an information terminal or the like of the user. The control unit 53 outputs information on the parking control and the exiting control to the information terminal or the like via the input and output unit 50.

When the vehicle 10 is positioned near the movement start point indicated by the parking information, the control unit 53 issues a notification that proposes execution of the movement control to the user, receives a response operation to the notification from the user, and inhibits the notification for proposing to the user according to non-execution of the movement control in response to the notification. Here, being positioned “near the movement star point” means that the vehicle 10 is positioned within a predetermined notification range from the movement start point. The notification range refers to a range in which the notified user such as the driver can recognize a parking frame, for example a range from which the driver can visually observe the parking frame. Specifically, the notification range is, for example, a range from equal to or greater than 5m to equal to or smaller than 10m from the vehicle 10 in accordance with a detection range of each camera. The range may be broader in accordance with the detection range of each camera in a case where the detection range of each camera is broader. The "movement control" refers to memory parking. However, it is also applicable to the case of memory exiting. The "non-execution of the movement control in response to the notification" means that a response operation to the notification for proposing to the user indicating that the movement control of the vehicle 10 will not be executed is received from the user. Non-execution of the movement control in response to the notification also includes that the reception of the response operation is ended in a state in which no response operation has been received yet. The reception is ended means that a predetermined time has elapsed since the notification, or that the vehicle 10 has left the movement start point by traveling, or the like.

The control unit 53 determines a traveling state related to the traveling of the vehicle 10, and if the traveling state of the vehicle 10 satisfies a predetermined condition, inhibits the notification that proposes execution of the movement control to the user (or does not notify at all), even when the vehicle 10 is positioned near the movement start point indicated by the parking information. The "traveling state" includes, for example, at least one of an accelerator opening degree, a travel speed, a traveling direction, and shift information. The "predetermined condition" refers to a state in which it can be assumed that the user has no intention of parking. In the case where the traveling state is the accelerator opening degree, the predetermined condition is that a depression amount of the accelerator pedal is large or a time for which the accelerator pedal is depressed is long. In the case where the traveling state is the travel speed, the predetermined condition is that the travel speed exceeds a threshold or that a state in which the travel speed exceeds the threshold continues. In the case where the traveling state is the traveling direction, the predetermined condition is that the vehicle 10 is traveling toward an exit of the parking facility. In the case where the traveling state is the shift information, the predetermined condition is that a shift lever is in reverse (back gear).

While a navigation function is being executed, the control unit 53 inhibits the notification that proposes execution of the movement control to the user even when the vehicle 10 is positioned near the movement start point indicated by the parking information. When the navigation function is being executed, it is determined that the vehicle 10 has not yet reached a state in which the movement control to the parking section is performed on the vehicle 10, and the notification to the user is inhibited. However, the control unit 53 does not inhibit the notification that proposes execution of the movement control to the user for a period from when the vehicle 10 arrives at the destination and the navigation function ends until a predetermined time elapses. For a predetermined time after completion of navigation guidance, it is assumed that the vehicle 10 is in a parking facility and the user is attempting to park the vehicle 10, and therefore, the notification that proposes execution of the movement control to the user is not inhibited. However, after a predetermined time has elapsed since the destination was reached, it can be determined that parking has been completed if the user had attempted to park the vehicle 10, or that the user has no intention of parking the vehicle 10, or that the vehicle 10 has already left the parking facility, and therefore, notification to the user is inhibited again.

Even when the navigation function is being executed, the control unit 53 may not inhibit the execution proposal of the movement control during a period from when the vehicle 10 arrives at the destination until a predetermined time has elapsed, since there is a high possibility that the movement control will be executed. For example, when navigation including a plurality of transit points is performed using the navigation function, parking may be performed once the vehicle arrives at a transit point as one of the destinations without the navigation function being ended. In order to deal with such a case, even when the navigation function is being executed, the execution proposal of the movement control may not be inhibited until a predetermined time has elapsed since the vehicle 10 arrives at the destination.

When the vehicle 10 is positioned near the movement start point indicated by the parking information, the control unit 53 issues a notification that proposes execution of the movement control to the user, and inhibits the notification for proposing to the user according to execution of the movement control in response to the notification. For example, if the movement control is executed in response to the notification, it can be assumed that parking of the vehicle 10 in the parking section at this parking facility has been completed and there is no intention to park the vehicle 10 until the vehicle 10 is moved to another parking facility. Therefore, the notification to the user is inhibited until it is determined that the vehicle 10 has left the parking facility based on changes in the traveling state of the vehicle 10, position information of the vehicle 10, and the like.

Note that not only in the case of movement control in response to the notification, the control unit 53 may similarly inhibit the notification even in a case of movement control not in response to the notification, for example. For example, when the vehicle 10 is positioned near the movement start point and a notification is issued to the user proposing execution of the movement control, if the user performs a response operation to the notification indicating not executing the movement control, even if the user later changes his or her mind and presses the "parking assistance button" and decides to execute the movement control of the vehicle 10, the notification to the user will be inhibited.

The control unit 53 cancels the inhibition of the notification based on at least one of the acceleration of the vehicle 10 and the depression amount of the accelerator pedal of the vehicle 10 after inhibiting the notification for proposing to the user, according to execution of the movement control in response to the notification. When the acceleration of the vehicle 10 or the depression amount of the accelerator pedal exceeds a threshold, it is determined that the vehicle 10 has started moving to another destination, and then the inhibition of notification is canceled.

According to the execution of the movement control in response to the notification, the control unit 53 cancels the inhibition of the notification when it is detected that the vehicle 10 has left the parking facility after inhibiting the notification for proposing to the user. Whether the vehicle 10 has left the parking facility may be detected based on GPS information, or may be detected based on recognition of features in the periphery recognition data.

The control unit 53 is capable of storing a plurality of pieces of parking information indicating the movement start point, the parking section, and the route from the movement start point to the parking section, and inhibits the notification to the user based on first parking information included in the plurality of pieces of the parking information according to non-execution of the movement control in response to the notification that proposes execution of the movement control to the user based on the first parking information.

After inhibiting the notification to the user based on the first parking information, the control unit 53 cancels the inhibition of the notification if the vehicle 10 travels a predetermined distance or more from a point where the notification based on the first parking information was issued. For example, when the vehicle 10 has traveled a distance twice a travel distance in memory parking, the control unit 53 determines that the vehicle 10 has left the parking facility and cancels the inhibition of the notification.

After inhibiting the notification to the user based on the first parking information according to the non-execution of the movement control in response to the notification based on the first parking information when the vehicle 10 passes in a first direction near the movement start point indicated by the first parking information, the control unit 53 cancels the inhibition of the notification if the vehicle 10 travels in a direction different from the first direction near the movement start point indicated by the first parking information. For example, when the control unit 53 detects that the vehicle 10 has traveled, for example in an opposite direction, near the same movement start point while the notification is being inhibited, the control unit 53 determines that the vehicle 10 has left (or has an intention of leaving) the parking facility, and cancels the inhibition of the notification.

The control unit 53 cancels the inhibition of the notification if it is detected that, in a parking facility including a plurality of parking areas, the vehicle 10 has moved across the parking areas after inhibiting the notification to the user based on the first parking information.

The control unit 53 may cancel the inhibition of the notification according to an operation (for example, pressing a "notification inhibition cancellation button") performed by the user when the notification that proposes execution of movement control to the user is being inhibited.

An EPS system 22 includes a steering angle sensor 100, a torque sensor 102, an EPS motor 104, a resolver 106, and an EPS ECU 108. The steering angle sensor 100 detects a steering angle θst of the steering 110. The torque sensor 102 detects a torque TQ applied to the steering 110.

The EPS motor 104 applies a driving force or a reaction force to a steering column 112 coupled to the steering 110, thereby providing support for the user’s operation on the steering 110 and automatic steering during the parking assistance. The resolver 106 detects a rotation angle θm of the EPS motor 104. The EPS ECU 108 controls the entire EPS system 22. The EPS ECU 108 includes an input and output unit (not illustrated), a calculation unit (not illustrated), and a storage unit (not illustrated).

The communication unit 24 enables wireless communication with another communication device 120. Another communication device 120 includes a base station, a communication device of another vehicle, an information terminal such as a smartphone or a tablet carried by the user of the vehicle 10, and the like. For example, the communication unit 24 includes an ultra wide band (UWB, registered trademark) interface or the like that can execute UWB communication with the information terminal. The communication unit 24 can transmit and receive information on memory parking and exiting and assisted parking and exiting of the vehicle 10 to and from an information terminal or the like.

The driving force control system 26 includes a driving ECU 130. The driving force control system 26 executes driving force control of the vehicle 10. The driving ECU 130 controls a driving force of the vehicle 10 by controlling an engine or the like (not illustrated) based on an operation performed by the user on the accelerator pedal (not illustrated).

The braking force control system 28 includes a braking ECU 132. The braking force control system 28 executes braking force control of the vehicle 10. The braking ECU 132 controls a braking force of the vehicle 10 by controlling a braking mechanism or the like (not illustrated) based on an operation performed by the user on the brake pedal (not illustrated).

### Parking Information in Parking Facility

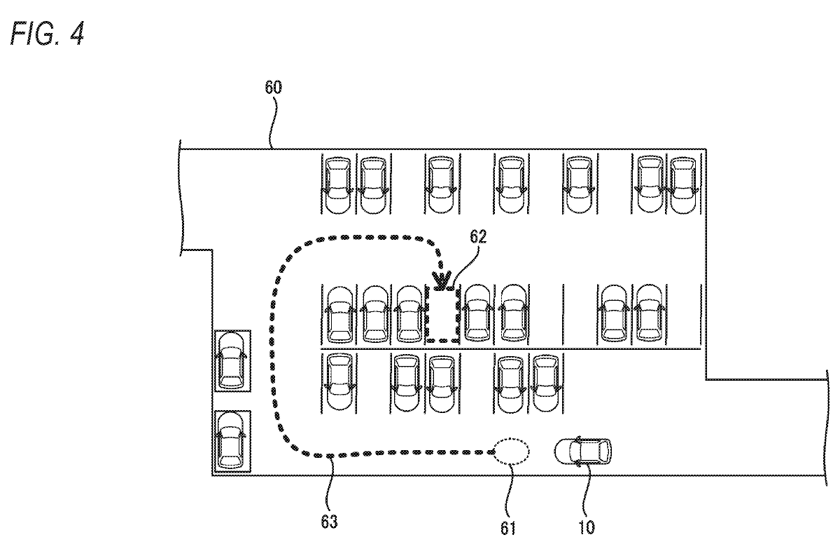

FIG. 4 is a diagram illustrating an example of parking information for the vehicle 10 in a parking facility. A parking facility 60 illustrated in FIG. 4 is a parking facility frequently used by the user of the vehicle 10, and is, for example, a parking facility at a shopping mall. The user of the vehicle 10 frequently uses a parking section 62 among the plurality of parking sections in the parking facility 60 as a place to park the vehicle 10, and registers the parking section 62 in the storage unit 54 as a parking section in which the memory parking can be performed. As illustrated in FIG. 4, the parking section 62 is registered in the storage unit 54 as parking information together with, for example, a movement start point 61 of the vehicle 10 when executing the memory parking and a route 63 (dashed arrow) along which the vehicle 10 travels from the movement start point 61 to the parking section 62.

To register the parking information, first, the user manually drives the vehicle 10 to travel and stops the vehicle 10 at any movement start point (for example, the movement start point 61). Next, the user presses, for example, a "parking information registration button" to register parking information on the memory parking. In this way, the registration of the parking information is started. The user manually drives the vehicle 10 to travel along any route (for example, route 63) and parks the vehicle 10 in any parking section (for example, parking section 62). Next, the user ends the registration of the parking information by, for example, pressing a "parking information registration ending button". In this way, the registration of the parking information is completed. Note that the route 63 shown in the present embodiment is displayed in a simplified manner, but may include a route that requires a quick turn, for example, when backing the vehicle 10 into the parking section 62. The parking information may also include features recognized based on the periphery recognition data of the route 63.

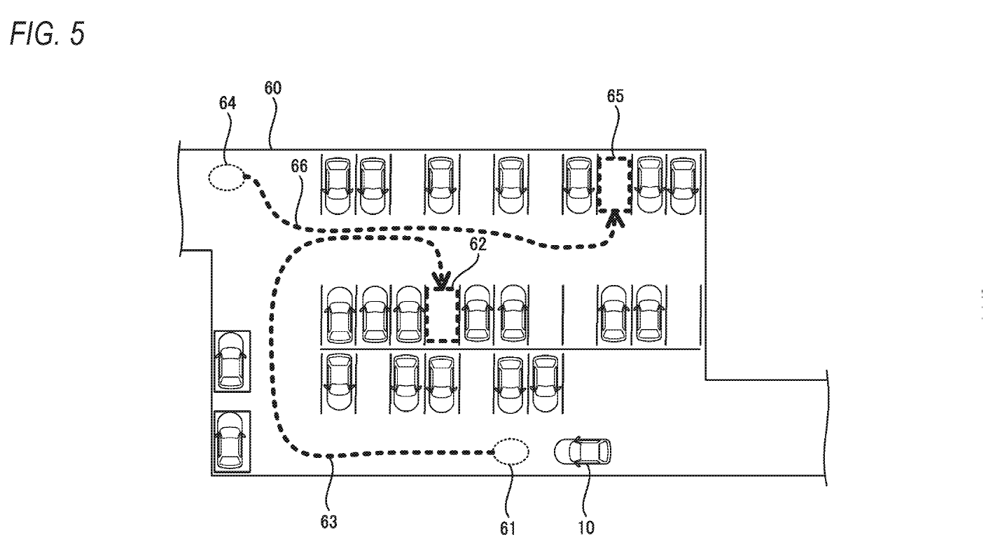

FIG. 5 is a diagram illustrating an example of a plurality of pieces of parking information in the parking facility 60. As illustrated in FIG. 5, the parking information for the vehicle 10 may include a plurality of different pieces of parking information registered in one parking facility 60. For example, in addition to the parking information indicating the movement start point 61, the parking section 62, and the route 63 described with reference to FIG. 4, parking information indicating a movement start point 64, a parking section 65, and a route 66 may be registered in the storage unit 54.

Note that in the present embodiment, a case has been described in which two pieces of parking information in the parking facility 60 are registered, but the present invention is not limited thereto, and for example, three or more pieces of parking information may be registered. In the parking information, the parking sections may be repeated, and the movement start points may be repeated. For example, a plurality of parking sections may be associated with each of the movement start points 61 and 64, and a plurality of movement start points may be associated with each of the parking sections 62 and 65.

### First Example of Control Processing Related to Memory Parking

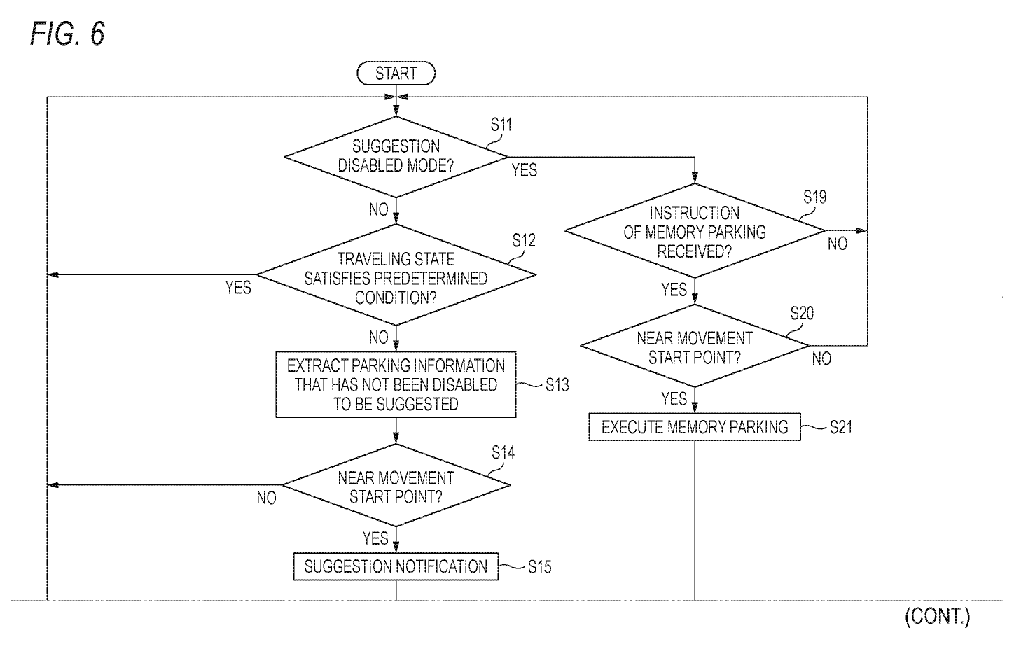

FIG. 6 is a flowchart illustrating a first example of control processing relating to the memory parking. This control processing is executed repeatedly while the vehicle 10 is traveling.

First, the vehicle 10 determines whether a mode of the movement control of the vehicle 10 is a "suggestion disabled mode" (step S11). The "suggestion" refers to performing a notification that proposes execution of movement control to the user when the vehicle 10 is positioned near a movement start point (for example, the movement start point 61 or 64). The "suggestion disabled mode" refers to a mode in which the notification that proposes execution of movement control to the user is inhibited. Note that the mode for suggestion may become an enabled mode (a mode in which the notification is not inhibited) by default.

When it is determined in step S11 that the vehicle 10 is not in the suggestion disabled mode (step S11: No), the vehicle 10 determines whether the traveling state thereof satisfies a predetermined condition (step S12). "The traveling state thereof satisfies a predetermined condition" means a state in which the accelerator opening degree, the travel speed, the traveling direction, the shift information, and the like as described above indicate that the user has no intention of parking.

In step S12, if the traveling state satisfies a predetermined condition (step S12: Yes), the vehicle 10 returns to step S11 and executes the processing of each step. In other words, even when the vehicle is not in the suggestion disabled mode (notification to the user is not inhibited), if the traveling state satisfies a predetermined condition, the user will not be notified of the proposal (notification is inhibited).

In step S12, if the traveling state does not satisfy the predetermined condition (step S12: No), the vehicle 10 extracts parking information that has not been disabled to be suggested from the storage unit 54 (step S13). The "parking information that has not been disabled to be suggested" refers to, for example, when a plurality of pieces of parking information on a parking facility is stored, the parking information that has not been disabled on the parking facility. As described with reference to FIG. 5, when there are two (plural) pieces of parking information on the parking facility 60, the "parking information on which the suggestion has not been disabled" refers to the piece of parking information that has not been disabled between the two pieces of parking information.

Next, the vehicle 10 determines whether the vehicle 10 is positioned near the movement start point indicated by the parking information extracted in step S13 (step S14). Whether the vehicle is positioned near the movement start point is detected based on, for example, GPS information or features in the periphery recognition data.

In step S14, if the position of the vehicle 10 is not near the movement start point (step S14: No), the vehicle 10 returns to step S11 and executes the processing of each step. In other words, it is determined that the vehicle 10 is not yet in a state in which memory parking can be started, and the vehicle 10 returns to step S11.

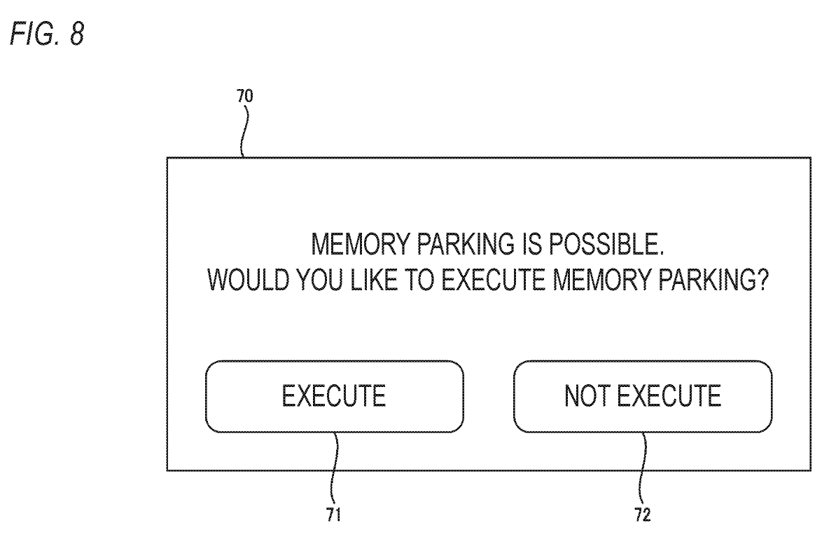

In step S14, if the position of the vehicle 10 is near the movement start point (step S14: Yes), the vehicle 10 issues a suggestion notification that proposes execution of the memory parking to the user of the vehicle 10 (step S15). A specific example of the suggestion notification will be described below with reference to FIG. 8.

Next, the vehicle 10 determines whether a response operation to the suggestion notification in step S15 is received from the user, that is, whether an instruction to execute the memory parking is received (step S16).

In step S16, if an instruction of memory parking is received (step S16: Yes), the vehicle 10 travels along the route indicated by the parking information and executes the memory parking in the parking section, and when the memory parking is completed, sets the suggestion mode to the disabled mode (step S17).

In step S16, if no instruction of memory parking is received (step S16: No), the vehicle 10 disables suggestions to the user relating to the memory parking executed based on target parking information (step S18). Examples of cases where the instruction of memory parking is not received include a case where an instruction of not executing memory parking is received, a case where a predetermined time elapses since the suggestion notification is issued and a timeout occurs, and a case where the vehicle 10 moves more than a predetermined distance and the memory parking cannot be executed. The target parking information is, for example, in the case of FIG. 5, the parking information indicating the movement start point 61, the parking section 62, and the route 63, or the parking information indicating the movement start point 64, the parking section 65, and the route 66.

On the other hand, if it is determined in step S11 that the vehicle 10 is in the suggestion disabled mode (step S11: Yes), the vehicle 10 determines whether an instruction of executing memory parking is received from the user (step S19). In this case, the instruction of executing memory parking is given by pressing the "parking assistance button".

In step S19, if the instruction of memory parking is not received (step S19: No), the vehicle 10 returns to step S11 and executes the processing of each step. In step S19, if an instruction of memory parking is received (step S19: Yes), the vehicle 10 determines whether the vehicle 10 is positioned near the movement start point indicated by the parking information (step S20).

In step S20, if the position of the vehicle 10 is not positioned near the movement start point (step S20: No), the vehicle 10 returns to step S11 and executes the processing of each step. In step S20, if the position of the vehicle 10 is near the movement start point (step S20: Yes), the vehicle 10 travels along the route indicated by the parking information and executes the memory parking in the parking section (step S21).

Note that in the processing of step S18, when the instruction of memory parking is not received, only the suggestion of the target parking information is disabled, but the present invention is not limited thereto. For example, if no instruction of memory parking is received, suggestions of all pieces of parking information may be disabled.

### Second Example of Control Processing Related to Memory Parking

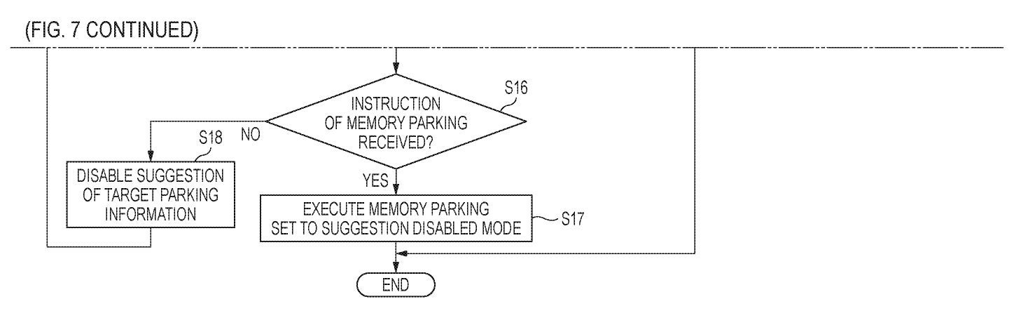

FIG. 7 is a flowchart illustrating a second example of control processing relating to the memory parking. As illustrated in FIG. 7, the processing in step S11 and from step S13 to step S21 is similar to the processing in step S11 and from step S13 to step S21 in the first example of the control processing in FIG. 6.

In the second example, if it is determined in step S11 that the vehicle 10 is not in the suggestion disabled mode (step S11: No), the vehicle 10 determines whether a function of the navigation device 18 is being executed (step S12A).

In step S12A, if the navigation function is being executed (step S12A: Yes), the vehicle 10 returns to step S11 and executes the processing of each step. That is, even when the vehicle 10 is not in the suggestion disabled mode (notification to the user is not inhibited), the user is not notified of any proposal (notification is inhibited) while the navigation function is being executed.

In step S12A, if the navigation function is not being executed (step S12A: No), the vehicle 10 extracts parking information that has not been disabled to be suggested from the storage unit 54 (step S13).

Note that in step S12A, even when the navigation function is being executed, the vehicle 10 may proceed to step S12A: No (not inhibit the suggestion notification) until the vehicle 10 arrives at a destination in the navigation and a predetermined time elapses since arriving at the destination. The determination processing of determining whether the navigation function is being executed (step S12A) may be executed in combination with the control processing in the first example of FIG. 6.

### Suggestion Screen

FIG. 8 is a diagram illustrating an example of a suggestion screen that proposes execution of movement control (memory parking) to the user. A suggestion screen 70 of the present embodiment is an example of a suggestion screen that is displayed when parking the vehicle 10 in a parking section. The suggestion screen 70 is displayed on, for example, the touch panel 42 of the navigation device 18.

As illustrated in FIG. 8, the suggestion screen 70 displays a notification message that proposes execution of the memory parking to the user, such as "Memory parking is possible. Would you like to execute memory parking?". The suggestion screen 70 displays an "Execute" button 71 and a "Don't execute" button 72 for receiving from the user a response operation to the notification message. Note that the suggestion notification may be performed by audio output or the like. The response operation to the suggestion notification may also be performed by voice input or the like.

As a result, when memory parking of the vehicle 10 is possible, the user simply needs to touch the "Execute" button 71 or the "Don't execute" button 72 for the memory parking in response to the suggestion notification displayed on the touch panel 42 of the navigation device 18. Therefore, when there is an intention to perform memory parking of the vehicle 10, there is no need to operate the touch panel 42 to request memory parking, and there is no need to check and press the displayed "memory parking button", thereby improving operability.

### Cancellation of Suggestion Disabled Mode

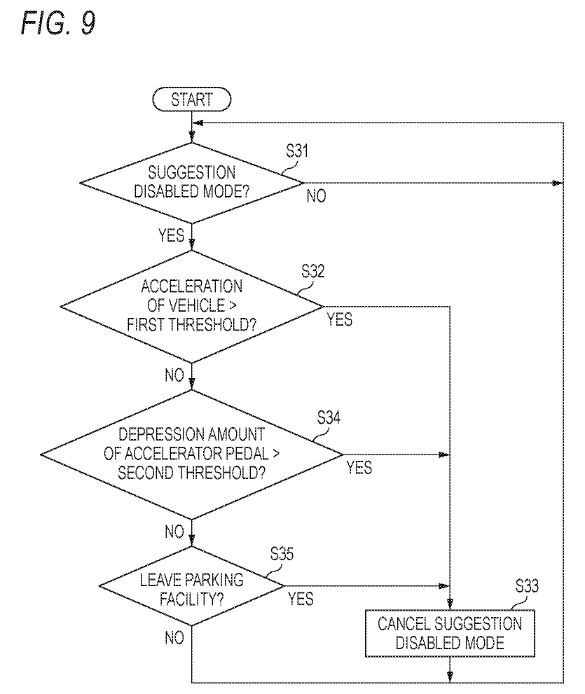

FIG. 9 is a flowchart illustrating cancellation processing for canceling the suggestion disabled mode. The cancellation processing is executed in parallel with the first example of the control processing described with reference to FIG. 6 and the second example of the control processing described with reference to FIG. 7.

First, the vehicle 10 determines whether a mode of the movement control of the vehicle 10 is the "suggestion disabled mode" (step S31). As described above, the "suggestion disabled mode" refers to a mode in which the notification that proposes execution of movement control to the user is inhibited.

If it is determined in step S31 that the vehicle 10 is not in the suggestion disabled mode (step S31: No), the vehicle 10 repeats the determination processing of step S31. If it is determined in step S31 that the vehicle 10 is in the suggestion disabled mode (step S31: Yes), the vehicle 10 determines whether a current acceleration of the vehicle 10 is greater than a first threshold (step S32).

If it is determined in step S32 that the acceleration of the vehicle 10 is greater than the first threshold (step S32: Yes), the vehicle 10 cancels the suggestion disabled mode (step S33) and then returns to step S31 to execute the processing of each step. When the acceleration of the vehicle 10 exceeds the first threshold, it is determined that the vehicle 10 has started moving to another destination, and the inhibition of the suggestion notification to the user is canceled.

If it is determined in step S32 that the acceleration of the vehicle 10 is equal to or less than the first threshold (step S32: No), the vehicle 10 determines whether the current depression amount of the accelerator pedal of the vehicle 10 is greater than a second threshold (step S34).

If it is determined in step S34 that the depression amount of the accelerator pedal of the vehicle 10 is greater than the second threshold (step S34: Yes), the vehicle 10 cancels the suggestion disabled mode (step S33) and then returns to step S31 to execute the processing of each step. When the depression amount of the accelerator pedal of the vehicle 10 exceeds the second threshold, it is determined that the vehicle 10 has started moving to another destination, and the inhibition of the suggestion notification to the user is canceled.

If it is determined in step S34 that the depression amount of the accelerator pedal of the vehicle 10 is equal to or less than the second threshold (step S34: No), the vehicle 10 determines whether the vehicle 10 has left the parking facility (step S35). whether the vehicle has left the parking facility is detected based on, for example, GPS information or the features in the periphery recognition data.

If it is determined in step S35 that the vehicle 10 has left the parking facility (step S35: Yes), the vehicle 10 cancels the suggestion disabled mode (step S33) and then returns to step S31 to execute the processing of each step. When the vehicle 10 leaves the parking facility, it is determined that there is no intention of performing memory parking of the vehicle 10, and the inhibition of the suggestion notification to the user is canceled.

If it is determined in step S35 that the vehicle 10 has not left the parking facility (step S35: No), the vehicle 10 returns to step S31 and executes the processing of each step.

Note that the suggestion disabled mode of the vehicle 10 may be cancelled by the an operation from the user, for example, by pressing a "suggestion disabling cancel button".

### Cancellation of Disabling of Suggestion

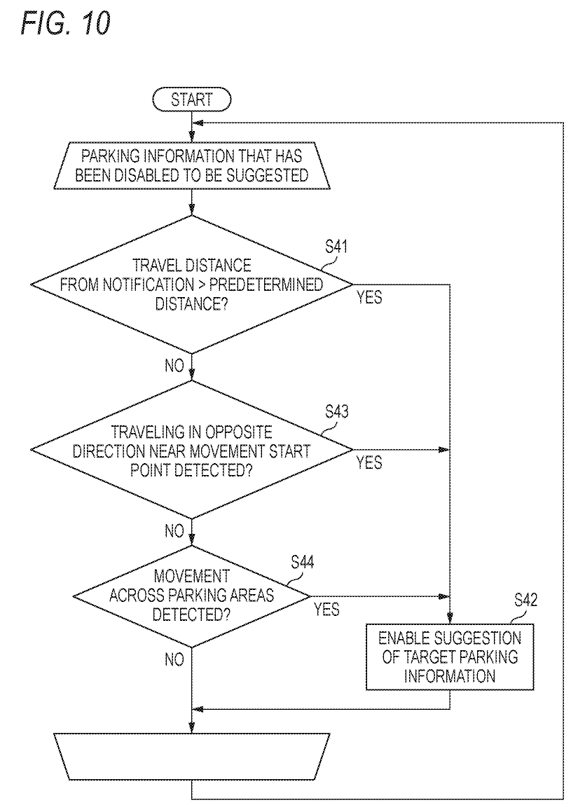

FIG. 10 is a flowchart illustrating cancellation processing for canceling disabling of a suggestion. The cancellation processing is executed in parallel with the first example of the control processing described with reference to FIG. 6 or the second example of the control processing described with reference to FIG. 7, similar to the cancellation processing of the suggestion disabled mode in FIG. 9.

The vehicle 10 executes a series of processing (steps S41 to S44) for each piece of parking information which has been disabled to be suggested. First, the vehicle 10 determines whether a travel distance of the vehicle 10 from the point where the notification was issued exceeds a predetermined distance (step S41).

In step S41, if the travel distance from the point where the notification was issued exceeds a predetermined distance (step S41: Yes), the vehicle 10 enables the target parking information to be suggested (step S42). When the travel distance of the vehicle 10 exceeds a predetermined distance, it is determined that the vehicle 10 has left the parking facility, and the vehicle 10 cancels the inhibition of the suggestion notification to the user.

In step S41, if the travel distance from the point where the notification was issued does not exceed a predetermined distance (step S41: No), the vehicle 10 determines whether it is detected the vehicle 10 travels in an opposite direction near the movement start point in the target parking information (step S43).

In step S43, when the vehicle 10 is detected traveling in the opposite direction near the movement start point (step S43: Yes), the vehicle 10 enables the target parking information to be suggested (step S42). When the vehicle 10 travels near the same movement start point in the opposite direction to a direction of the route in the parking information, it is determined that the vehicle 10 has left the parking facility (or has an intention to leave), and the vehicle 10 cancels the inhibition of the suggestion notification to the user.

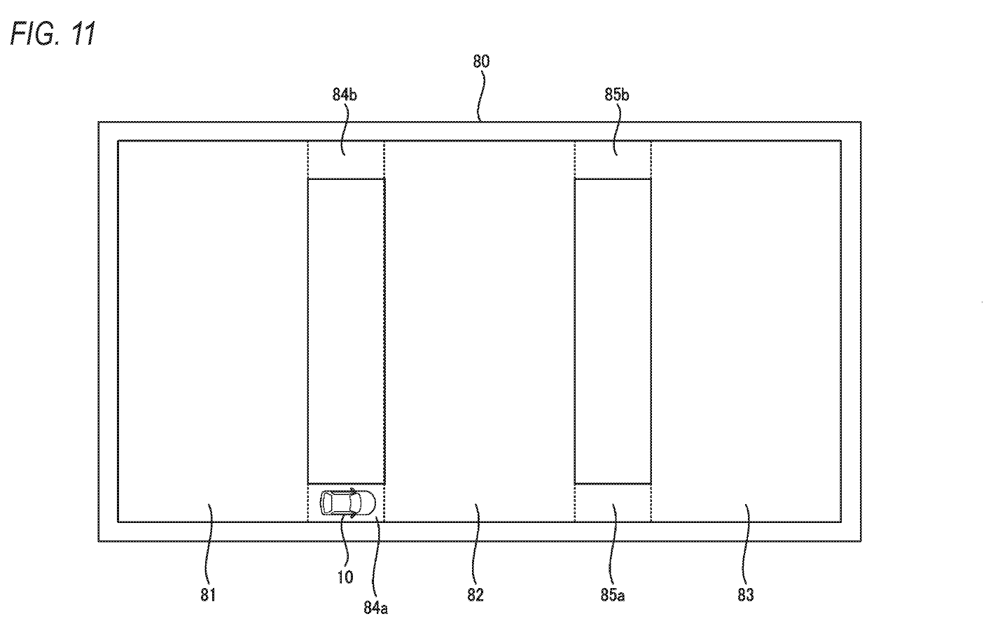

In step S43, if the vehicle 10 is not detected traveling in the opposite direction near the movement start point (step S43: No), the vehicle 10 determines whether movement of the vehicle 10 across parking areas has been detected, for example, in a parking facility that includes a plurality of parking areas (step S44). The parking facility including a plurality of parking areas is described below with reference to FIG. 11.

In step S44, if movement across parking areas is detected (step S44: Yes), the vehicle 10 enables the target parking information to be suggested (step S42). When the vehicle 10 moves to another parking area, it is determined that there is no intention of performing memory parking in the parking area before the movement, and the vehicle 10 cancels the inhibition of the suggestion notification to the user.

In step S44, if no movement across parking areas is detected (step S44: No), the vehicle 10 ends the series of processing (steps S41 to S44) regarding the target parking information. Then, the vehicle 10 repeatedly executes the series of processing (steps S41 to S44) on each piece of parking information that has been disabled to be suggested.

Note that the enabling of the suggestion of the target parking information may be cancelled by an operation from the user, for example, by pressing a "notification inhibition cancellation button".

### Parking Facility Including Plurality of Parking Areas

FIG. 11 is a diagram illustrating an example of a parking facility including a plurality of parking areas. As illustrated in FIG. 11, a parking facility 80 is a parking facility including, for example, a first parking area 81, a second parking area 82, and a third parking area 83. Between the first parking area 81 and the second parking area 82, passages 84a and 84b are provided for allowing the vehicle 10 to move across the two parking areas. Similarly, passages 85a and 85b are provided between the second parking area 82 and the third parking area 83 for allowing the vehicle 10 to move across the two parking areas.

In the parking facility 80 including a plurality of parking areas, whether the vehicle 10 has moved across the parking areas is determined based on whether the vehicle 10 has traveled through any of the passages 84a, 84b, 85a, and 85b. Whether the vehicle 10 has traveled through the passage 84a, 84b, 85a, or 85b is detected based on, for example, GPS information or features in the periphery recognition data.

As described above, the control device of the present embodiment issues a notification that proposes execution of memory parking to the user when the vehicle 10 approaches the movement start point 61 indicated by the parking information, and when a response to the notification from the user is non-execution of the memory parking, the notification of execution proposal to the user will be inhibited even when the vehicle 10 approaches the movement start point 61 then. With this configuration, annoyance felt by the user due to the execution proposal of memory parking more than necessary, and trouble of the user having to change settings to not performing memory parking every time the user receives the execution proposal are eliminated. By reducing the number of times of notification processing, power consumption of the control device can be reduced. Furthermore, in a case where information on the notification is managed by, for example, an external server device, the number of times of communication processing with the server device can be reduced, leading to a reduction in the power consumption. Accordingly, usability near the parking section 62 indicated by the parking information can be improved.

Even when the control device inhibits the notification of the execution proposal of memory parking, if the vehicle 10 travels a predetermined distance or more from the point where the notification was issued, it is determined that the vehicle 10 has left the parking facility and the inhibition of the notification of the execution proposal is canceled. Even when the control device inhibits the notification of the execution proposal of memory parking, if the vehicle travels near the movement start point in a direction different from the direction in which the vehicle travels when the execution proposal was made, it is determined that the vehicle 10 has left the parking facility and the inhibition of the notification of the execution proposal is canceled. Even when the control device inhibits the notification of the execution proposal of memory parking, if the vehicle 10 moves across parking areas, it is determined that there is no intention of performing memory parking in the parking area before the movement, and the inhibition of the notification of the execution proposal is canceled. In this way, there is no need for the user to perform cancellation operation for the notification inhibition regarding the parking information, and usability near the parking section is further improved.

When conditions are satisfied, such as the depression amount of the accelerator pedal of the vehicle 10 is large or the travel speed exceeds a threshold, or when the navigation function is being executed, the control device determines that the user has no intention of performing the memory parking, and inhibits the notification of execution proposal of memory parking even when the vehicle 10 approaches the movement start point. In this way, it is possible to improve the usability near the parking section in the same manner as described above.

When the vehicle 10 approaches the movement start point 61 indicated by the parking information, the control device issues a notification that proposes execution of memory parking to the user, and if memory parking is executed in response to the notification, the control device determines that parking at the parking facility is completed, and disables the mode of proposing memory parking until it is determined that the vehicle 10 has left the parking facility, thereby inhibiting the notification of execution proposal to the user. In this way, it is possible to improve the usability near the parking section in the same manner as described above.

Even when the control device inhibits the notification of execution proposal of memory parking, if the acceleration of the vehicle 10 or the depression amount of the accelerator pedal exceeds a threshold, it is determined that movement to another destination has begun and the inhibition of the notification of the execution proposal is canceled. Even when the control device inhibits the notification of execution proposal of memory parking, the control device cancels the inhibition of the notification of execution proposal when leaving of the vehicle 10 from the parking facility is detected. In this way, there is no need for the user to perform cancellation operation for the notification inhibition regarding the proposing mode, and usability near the parking section is further improved.

Note that the control method described in the above embodiment may be implemented by executing a control program prepared in advance by a computer. The control program is stored in a computer-readable storage medium and executed by being read from the storage medium. Further, the control program may be provided in a form stored in a non-transitory storage medium such as a flash memory, or may be provided via a network such as the Internet. The computer that executes the control program may be provided in the control device, may be provided in an electronic device such as a smartphone, a tablet terminal, or a personal computer that can communicate with the control device, or may be provided in a server device that can communicate with the control device and the electronic device.

The embodiment of the present disclosure has been described above, but the present invention is not limited to the embodiment described above, and modifications, improvements, and the like can be made as appropriate.

In the above embodiment, the vehicle is a four-wheeled automobile, but the vehicle is not limited thereto. For example, the vehicle may be a two-wheeled vehicle, a Segway, or the like. Further, the idea of the present invention is not limited to the vehicle, and may also be applied to a robot, a ship, an aircraft, or the like that includes a drive source and is movable by power of the drive source.

In the present specification, at least the following matters are described. Although corresponding constituent elements or the like in the embodiment described above are shown in parentheses, the present invention is not limited thereto.

(1) A control device (control ECU 20) that performs movement control to move a vehicle (vehicle 10) from a movement start point to a parking section based on parking information indicating the movement start point, the parking section, and a route from the movement start point to the parking section, the control device including:

processing circuitry (control unit 53) configured to

issue a notification that proposes execution of the movement control to a user in response to the vehicle being positioned near the movement start point indicated by the parking information,

receive a response operation to the notification from the user, and

inhibit the notification in response to non-execution of the movement control in relation to the notification.

According to (1), when the movement control is not executed in response to the notification that proposes execution of the movement control, the notification of the execution proposal is inhibited even when the movement start point is approached, and therefore, annoyance felt by the user due to the execution proposal of the movement control more than necessary, and trouble of the user for changing settings to not performing the movement control every time the user receives the execution proposal are eliminated, and usability near the parking section can be improved.

(2) The control device according to (1), in which

the processing circuitry is configured to

determine a traveling state of the vehicle, and

inhibit the notification in response to the traveling state satisfying a predetermined condition even when the vehicle is positioned near the movement start point indicated by the parking information.

According to (2), when a traveling state of the vehicle satisfies a predetermined condition, the notification of the execution proposal is inhibited even when the movement start point is approached, thereby improving the usability near the parking section.

(3) The control device according to (1) or (2), in which

the control device has a navigation function of providing a guide along a movement route for the vehicle to travel from a current location to a destination, and

the processing circuitry is configured to inhibit the notification during execution of the navigation function even when the vehicle is positioned near the movement start point indicated by the parking information.

According to (3), while the navigation function is being executed, the notification of the execution proposal is inhibited even when the movement start point is approached, thereby improving the usability near the parking section.

(4) The control device according to (3), in which

the processing circuitry is configured to inhibit the notification after a predetermined time elapses from when the vehicle arrives at the destination and the navigation function ends.

As in (4), since there is a high possibility that the movement control will be executed during a period from when the destination is reached and the navigation function is ended until a predetermined time elapses, it is preferable not to inhibit the execution proposal of movement control.

(5) The control device according to (3), in which

while the navigation function is executed, the processing circuitry is configured to inhibit the notification after predetermined time elapses after the vehicle arrives at the destination.

As in (5), even when the navigation function is being executed, there is a high possibility that the movement control will be executed during a period from arrival at the destination until a predetermined time elapses, and therefore, it is preferable not to inhibit the execution proposal of the movement control.

(6) The control device according to any one of (1) to (5), in which

in response to execution of the movement control in response to the notification, the processing circuitry is configured to inhibit the notification.

According to (6), when movement control is executed in response to the notification that proposes execution of movement control, the notification of the execution proposal is inhibited even when the movement start point is approached, thereby improving the usability near the parking section.

(7) The control device according to (6), in which

the processing circuitry is configured to cancel inhibition of the notification based on at least one of an acceleration of the vehicle or a depression amount of an accelerator pedal of the vehicle.

According to (7), even when the notification of the execution proposal of the movement control is inhibited, the inhibition of the execution proposal is canceled based on the acceleration of the vehicle or the depression amount of the accelerator pedal, thereby further improving the usability near the parking section.

(8) The control device according to (6) or (7), in which

the processing circuitry is configured to cancel inhibition of the notification in response to it being detected that the vehicle leaves a parking facility.

According to (8), even when the notification of the execution proposal of movement control is inhibited, the inhibition of the execution proposal is canceled if it is detected that the vehicle has left the parking facility, thereby further improving the usability near the parking section.

(9) The control device according to (1), in which

the processing circuitry is capable of storing a plurality of pieces of parking information, and is configured to, in response to non-execution of the movement control in response to the notification based on first parking information included in the parking information, inhibit the notification based on the first parking information.

According to (9), even when a plurality of pieces of parking information are stored, and if the movement control is not executed in response to the notification that proposes execution of the movement control, the execution proposal is inhibited even when the movement start point is approached, and therefore, annoyance felt by the user due to the execution proposal of the movement control more than necessary, and trouble of the user for changing settings to not performing the movement control every time the user receives the execution proposal are eliminated, and usability near the parking section can be improved.

(10) The control device according to (9), in which

the processing circuitry is configured to, after inhibiting the notification based on the first parking information, cancel inhibition of the notification in response to the vehicle traveling a predetermined distance or more from a point where the notification based on the first parking information is issued.

According to (10), even when the notification of the execution proposal of movement control is inhibited, the inhibition of the execution proposal is canceled if the vehicle travels a predetermined distance or more, thereby further improving the usability near the parking section.

(11) The control device according to (9) or (10), in which

the processing circuitry is configured to, after inhibiting the notification based on the first parking information according to the non-execution of the movement control in response to the notification based on the first parking information when the vehicle passes in a first direction near the movement start point indicated by the first parking information, cancel inhibition of the notification in response to the vehicle traveling in a direction different from the first direction near the movement start point indicated by the first parking information.

According to (11), even when the notification of the execution proposal of movement control is inhibited, if the vehicle travels near the movement start point in a direction different from the direction in which the vehicle traveled when the execution proposal was made, the inhibition of the execution proposal is canceled, thereby further improving the usability near the parking section.

(12) The control device according to any one of (9) to (11), in which

the processing circuitry is configured to cancel inhibition of the notification in response to it being detected that, in a parking facility including a plurality of parking areas, the vehicle moves across the parking areas after inhibiting the notification based on the first parking information.

According to (12), even when the notification of the execution proposal of movement control is inhibited, the inhibition of the execution proposal is canceled if the vehicle moves across parking areas, thereby further improving the usability near the parking section.

(13) The control device according to any one of (1) to (12), in which,

in response to a user operation while the notification is being inhibited, the processing circuitry is configured to cancel the inhibition of the notification.

According to (13), the inhibition of the execution proposal of the movement control can be canceled by an operation from the user, thereby further improving the usability near the parking section.

(14) A control method of a control device that performs movement control to move a vehicle from a movement start point to a parking section based on parking information indicating the movement start point, the parking section, and a route from the movement start point to the parking section, the control method including:

issuing, by the control device, a notification that proposes execution of the movement control to a user in response to the vehicle being positioned near the movement start point indicated by the parking information,

receiving, by the control device, a response operation to the notification from the user, and

inhibiting, by the control device, the notification in response to non-execution of the movement control in relation to the notification.

According to (14), when the movement control is not executed in response to the notification that proposes execution of the movement control, the notification of the execution proposal is inhibited even when the movement start point is approached, and therefore, annoyance felt by the user due to the execution proposal of the movement control more than necessary, and trouble of the user for changing settings to not performing the movement control every time the user receives the execution proposal are eliminated, and usability near the parking section can be improved.

(15) A non-transitory computer-readable storage medium storing a control program causing a processor of a control device to execute a process, the control device performing movement control to move a vehicle from a movement start point to a parking section based on parking information indicating the movement start point, the parking section, and a route from the movement start point to the parking section, the process including:

issuing a notification that proposes execution of the movement control to a user in response to the vehicle being positioned near the movement start point indicated by the parking information,

receiving a response operation to the notification from the user, and

inhibiting the notification in response to non-execution of the movement control in relation to the notification.

According to (15), when the movement control is not executed in response to the notification that proposes execution of the movement control, the notification of the execution proposal is inhibited even when the movement start point is approached, and therefore, annoyance felt by the user due to the execution proposal of the movement control more than necessary, and trouble of the user for changing settings to not performing the movement control every time the user receives the execution proposal are eliminated, and usability near the parking section can be improved.

What is claimed is:

1. A control device that performs movement control to move a vehicle from a movement start point to a parking section based on parking information indicating the movement start point, the parking section, and a route from the movement start point to the parking section, the control device comprising:
processing circuitry configured to
issue a notification that proposes execution of the movement control to a user in response to the vehicle being positioned near the movement start point indicated by the parking information,
receive a response operation to the notification from the user, and
inhibit the notification in response to non-execution of the movement control in relation to the notification.

2. The control device according to claim 1, wherein
the processing circuitry is configured to
determine a traveling state of the vehicle, and
inhibit the notification in response to the traveling state satisfying a predetermined condition even when the vehicle is positioned near the movement start point indicated by the parking information.

3. The control device according to claim 1, wherein
the control device has a navigation function of providing a guide along a movement route for the vehicle to travel from a current location to a destination, and
the processing circuitry is configured to inhibit the notification during execution of the navigation function even when the vehicle is positioned near the movement start point indicated by the parking information.

4. The control device according to claim 3, wherein
the processing circuitry is configured to inhibit the notification after a predetermined time elapses from when the vehicle arrives at the destination and the navigation function ends.

5. The control device according to claim 3, wherein
while the navigation function is executed, the processing circuitry is configured to inhibit the notification after predetermined time elapses after the vehicle arrives at the destination.

6. The control device according to claim 1, wherein
in response to execution of the movement control in response to the notification, the processing circuitry is configured to inhibit the notification.

7. The control device according to claim 6, wherein
the processing circuitry is configured to cancel inhibition of the notification based on at least one of an acceleration of the vehicle or a depression amount of an accelerator pedal of the vehicle.

8. The control device according to claim 6, wherein
the processing circuitry is configured to cancel inhibition of the notification in response to it being detected that the vehicle leaves a parking facility.

9. The control device according to claim 1, wherein
the processing circuitry is capable of storing a plurality of pieces of parking information, and is configured to, in response to non-execution of the movement control in response to the notification based on first parking information included in the parking information, inhibit the notification based on the first parking information.

10. The control device according to claim 9, wherein
the processing circuitry is configured to, after inhibiting the notification based on the first parking information, cancel inhibition of the notification in response to the vehicle traveling a predetermined distance or more from a point where the notification based on the first parking information is issued.

11. The control device according to claim 9, wherein
the processing circuitry is configured to, after inhibiting the notification based on the first parking information according to the non-execution of the movement control in response to the notification based on the first parking information when the vehicle passes in a first direction near the movement start point indicated by the first parking information, cancel inhibition of the notification in response to the vehicle traveling in a direction different from the first direction near the movement start point indicated by the first parking information.

12. The control device according to claim 9, wherein
the processing circuitry is configured to cancel inhibition of the notification in response to it being detected that, in a parking facility including a plurality of parking areas, the vehicle moves across the parking areas after inhibiting the notification based on the first parking information.

13. The control device according to claim 1, wherein,
in response to a user operation while the notification is being inhibited, the processing circuitry is configured to cancel inhibition of the notification.

14. A control method of a control device that performs movement control to move a vehicle from a movement start point to a parking section based on parking information indicating the movement start point, the parking section, and a route from the movement start point to the parking section, the control method comprising:
issuing, by the control device, a notification that proposes execution of the movement control to a user in response to the vehicle being positioned near the movement start point indicated by the parking information,
receiving, by the control device, a response operation to the notification from the user, and
inhibiting, by the control device, the notification in response to non-execution of the movement control in relation to the notification.

15. A non-transitory computer-readable storage medium storing a control program causing a processor of a control device to execute a process, the control device performing movement control to move a vehicle from a movement start point to a parking section based on parking information indicating the movement start point, the parking section, and a route from the movement start point to the parking section, the process comprising:
issuing a notification that proposes execution of the movement control to a user in response to the vehicle being positioned near the movement start point indicated by the parking information,
receiving a response operation to the notification from the user, and
inhibiting the notification in response to non-execution of the movement control in relation to the notification.
